(19) United States
(12) Patent Application Publication
(10) Pub. No.: US 2019/0086193 A1
(43) Pub. Date: Mar. 21, 2019

(54) CAMERA PROGRAM WITH IMAGE MEASUREMENT FOR MOBILE DEVICES

(71) Applicant: CONARY ENTERPRISE CO., LTD., Taipei City (TW)

(72) Inventor: HSIEN-CHENG YEN, TAIPEI CITY (TW)

(21) Appl. No.: 15/709,640

(22) Filed: Sep. 20, 2017

(51) Int. Cl. G01B 11/02; G01C 3/08; H04N 13/02; H04N 5/232

(52) U.S. Cl. CPC G01B 11/02; H04N 5/23293; H04N 13/0253; G01C 3/08

(57) ABSTRACT

A camera program with image measurement installed in a mobile device for taking an image with a laser point projected on a camera screen and storing the image in a memory unit. A microprocessor in the mobile device operates the camera program to obtain a position of the laser point by calculation and display a reference point on the camera screen. A base point is further determined near the reference point and connected to an end of a first measuring line, a second measuring line and a third measuring line; another end of each measuring line is respectively connected to a first, second and third measuring point for measurement. When operating image measurement, the base point is moved to a point of an object in the image and the first, second and third measuring points are separately moved to align with outline of the object for three-dimensional measurement.

### BACKGROUND OF THE INVENTION

### 1. Field of the Invention

The present invention relates to a camera program with image measurement, particularly to one that is installed on a mobile device and operated for three-dimensional measurement of objects in an image taken by the camera program.

### 2. Description of the Related Art

Measurements are important in many different industries such as architecture, interior decoration, and product manufacturing. Traditionally engineers' tapes are commonly used for measurements; then there is laser rangefinders widely applied for more convenient measurements. However, both tools can only perform measurements on scenes and the results have to be manually recorded, thereby leaving some room for improvement.

### SUMMARY OF THE INVENTION

A primary object of the present invention is to provide a camera program with image measurement function that is able to take photo of an image and perform a three-dimensional measurement instantly on a camera screen.

To achieve the objects mentioned above, the present invention comprises a mobile device including a microprocessor electrically connected to a touch screen, a memory unit and a camera lens; a laser module coupled to said mobile device and operated by said microprocessor of the mobile device to project a laser point; and a camera program installed in said memory unit and operated by said microprocessor to activate the laser module for projection, operate the camera lens and display a camera screen on said touch screen, said camera screen having a pre-arranged baseline and a region of interest.

Whereby the camera screen displays an object on a base plane and the laser point is projected onto the base plane for adjustment of the baseline on the camera screen in accordance with movement of the mobile device; the region of interest is focused on the laser point for taking an image of the camera screen with the object and the laser point therein and storing the image in the memory unit; the microprocessor operates the camera program to calculate a position of the laser point and display a reference point and then a first measuring line, a second measuring line and a third measuring line near said reference point, said first, second and third measuring lines connected to a basepoint with an end thereof and respectively having a first measuring point, a second measuring point and a third measuring point at another end of each measuring line; and the basepoint is moved to a point of the object for three-dimensional measurement by the first, second and third measuring points.

Furthermore, the camera screen displays a secondary window with a cross mark therein after the taking the image by the microprocessor, displaying a partially enlarged view of the image. A position of the basepoint on the camera screen is selected for operation and the first, second and third measuring points are selected for corresponding measuring lines to be adjusted for measurement; each measuring line has a measurement data displayed nearby on the camera screen. The camera screen further has a measurement button, a length unit switching button, a data managing button, a calibration button, a setting button, a laser button, a shutter button and an exposure adjusting button, and the measurement button further displays a distance measuring button, a line measuring button and an area measuring button.

After taking a photo of the image, a distance data between the laser module and the laser point projected on the image is transmitted to the microprocessor for display on the camera screen. Besides, the mobile device further comprises a gyroscope for collecting triaxial data and an accelerometer for collecting displacement data. The triaxial data and displacement data are then transmitted to the microprocessor for display on the camera screen.

The mobile device further comprises a wireless transmitter for transmission of taken image to another mobile device with the camera program, and the laser module is coupled to the mobile device either internally or externally.

With structures disclosed above, the present invention is able to perform three-dimensional measurement with a mobile device simply by a projected laser point after taking a photo of an image, instead of going through a complicated preparation for measurement tools to be ready for operation.

### BRIEF DESCRIPTION OF THE DRAWINGS

FIG. 1 is a block diagram illustrating a circuit connection of the present invention;

FIG. 2A is a schematic diagram displaying options of a measurement button on a camera screen;

FIG. 2B is a schematic diagram displaying a laser point, a baseline and a region of interest on the camera screen;

FIG. 2C is a schematic diagram illustrating the region of interest focused on the laser point on the camera screen;

FIG. 2D is a schematic diagram illustrating a shutter button on the camera screen being touched for image taking;

FIG. 2E is a schematic diagram illustrating an image being taken;

FIG. 2F is a schematic diagram displaying a reference point on the camera screen;

FIG. 2G is another schematic diagram illustrating the shutter button on the camera screen being touched for image taking;

FIG. 2H is a schematic diagram displaying a first measuring line, a second measuring line and a third measuring line on the camera screen;

FIG. 2I is a schematic diagram illustrating the reference point being moved to a point of an object on the camera screen;

FIG. 2J is a schematic diagram illustrating a first measuring point at an end of the first measuring line being moved on the camera screen for measurement of the object;

FIG. 2K is a schematic diagram illustrating a second measuring point at an end of the second measuring line being moved on the camera screen for measurement of the object;

FIG. 2L is a schematic diagram illustrating a third measuring point at an end of the third measuring line being moved on the camera screen for measurement of the object;

FIG. 2M is a schematic diagram displaying results of measurements of the object;

FIG. 3 is another schematic diagram displaying results of measurements in another image;

FIG. 4A is a schematic diagram displaying results of measurements in yet another image; and

FIG. 4B is another schematic diagram displaying a different set of results of measurements in the image of FIG. 4A.

### DETAILED DESCRIPTION OF THE PREFERRED EMBODIMENT

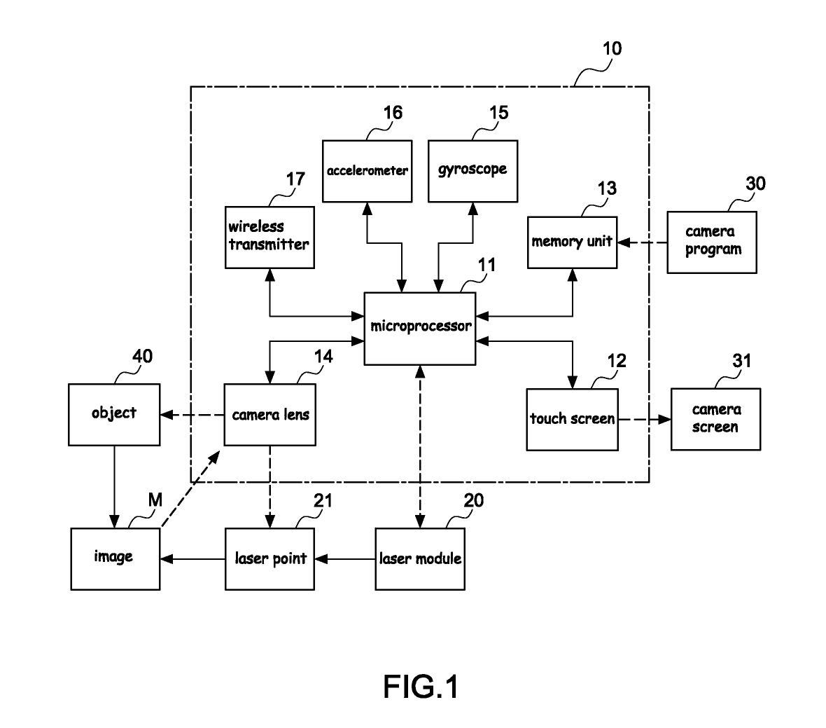

Referring to FIGS. 1-4B, a preferred embodiment of the present invention mainly comprises a mobile device 10, a laser module 20 and a camera program 30.

The mobile device 10 has a microprocessor 11 electrically connected to a touch screen 12, a memory unit 13 and a camera lens 14. The laser module 20 is coupled to the mobile device 10 and operated by the microprocessor 11 of the mobile device 10. In this embodiment, the laser module 20 can be coupled to the mobile device 10 either internally or externally. The camera program 30 is installed in the memory unit 13 of the mobile device 10 and operated by the microprocessor 11 to project a laser point 21, operate the camera lens 14 and display a camera screen 31 on the touch screen 12. The camera screen 31 has a pre-arranged baseline 311 and a region of interest 312.

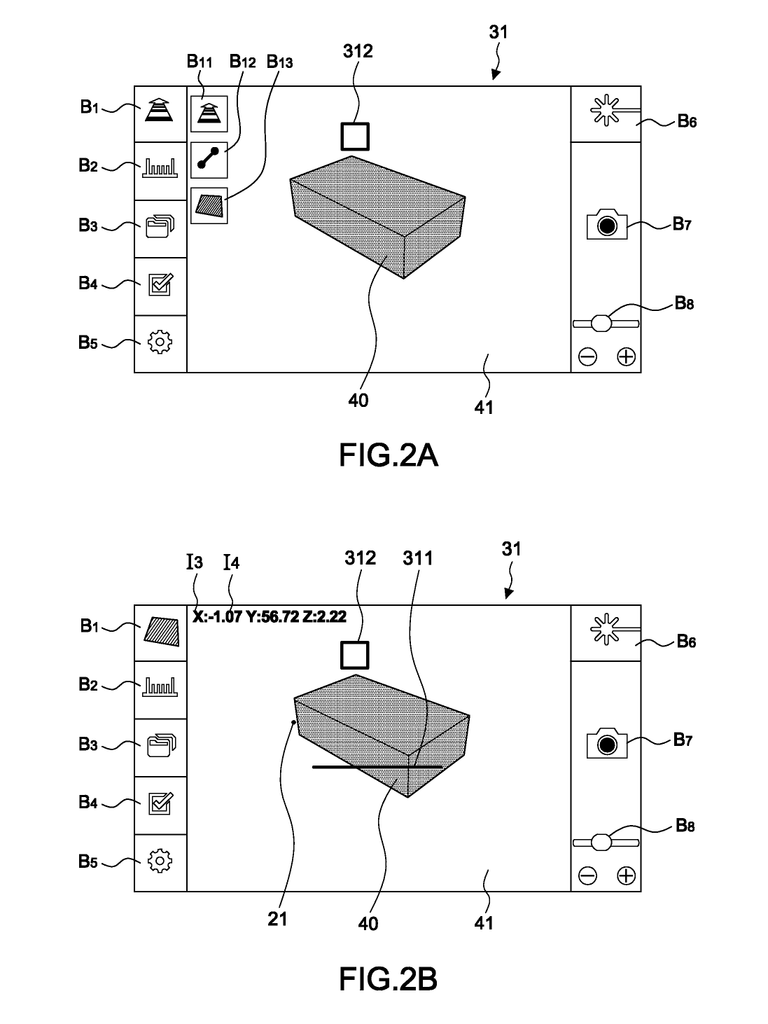

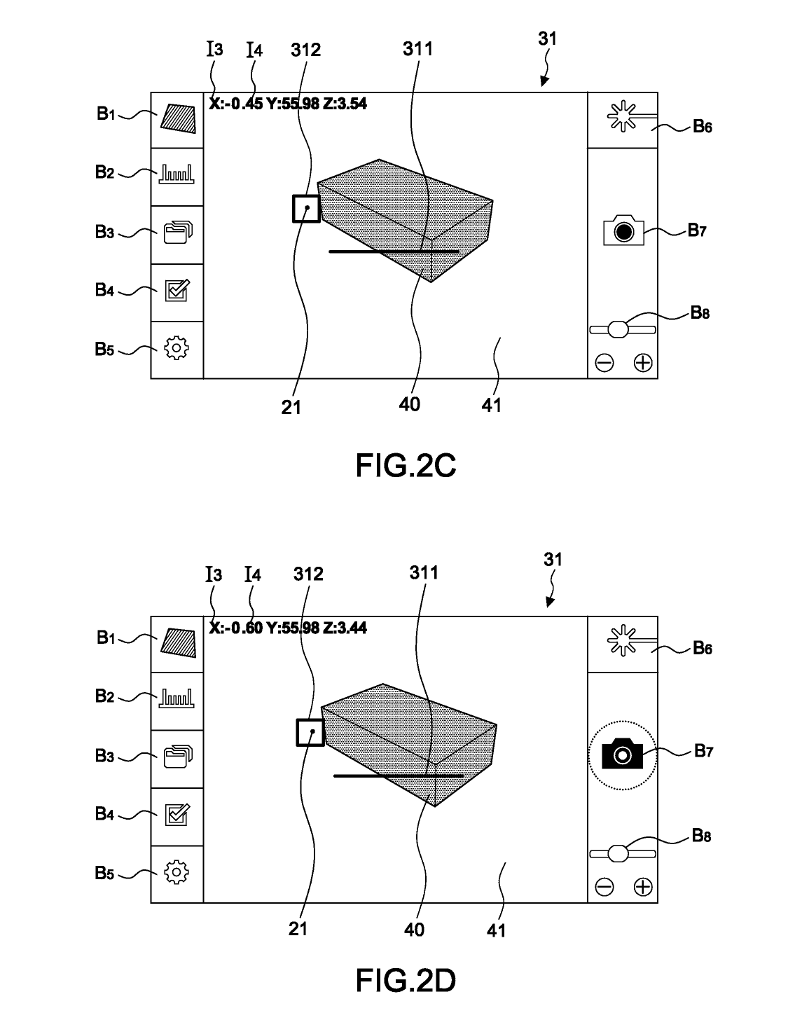

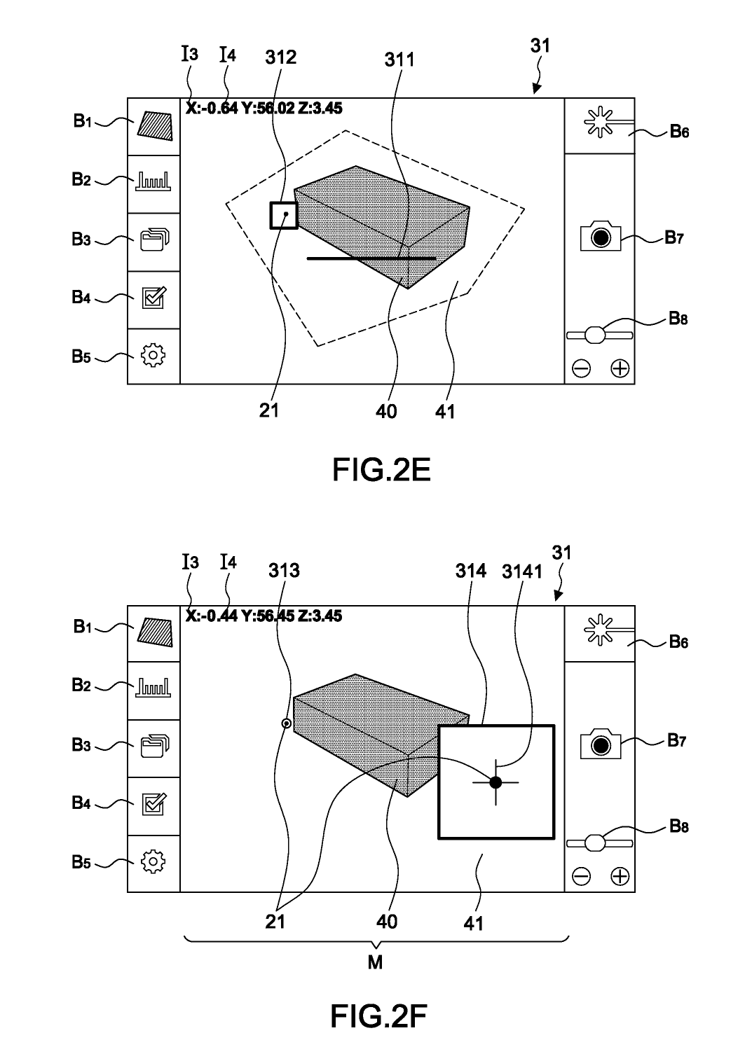

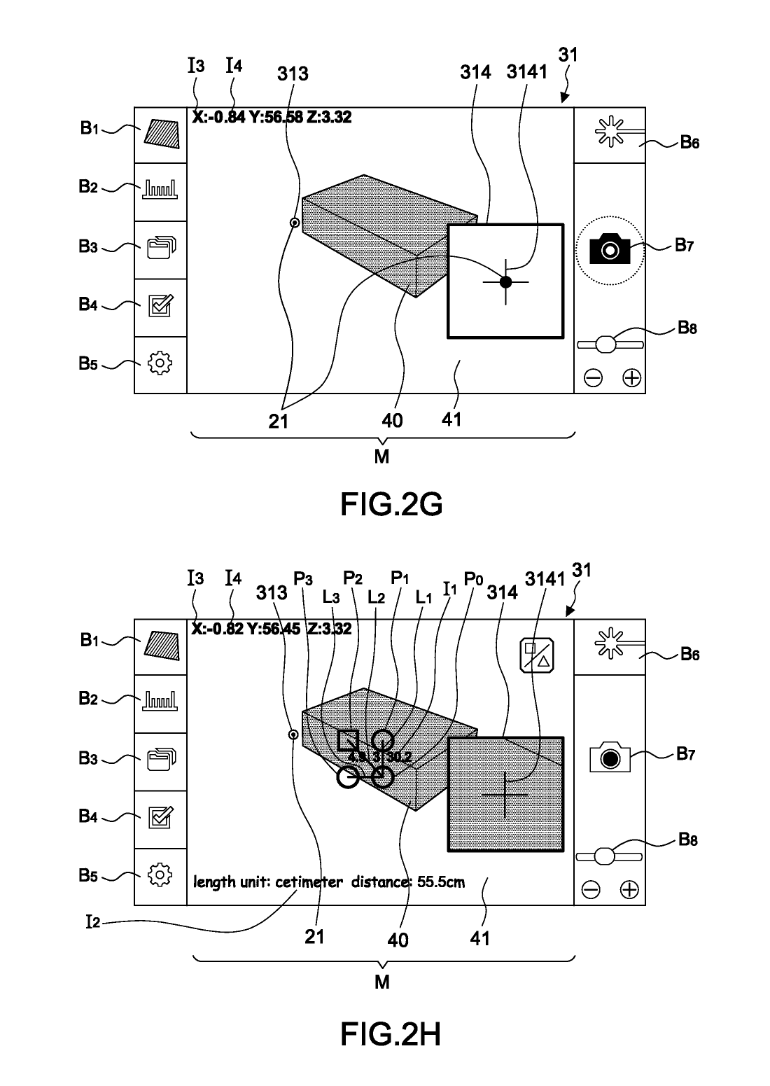

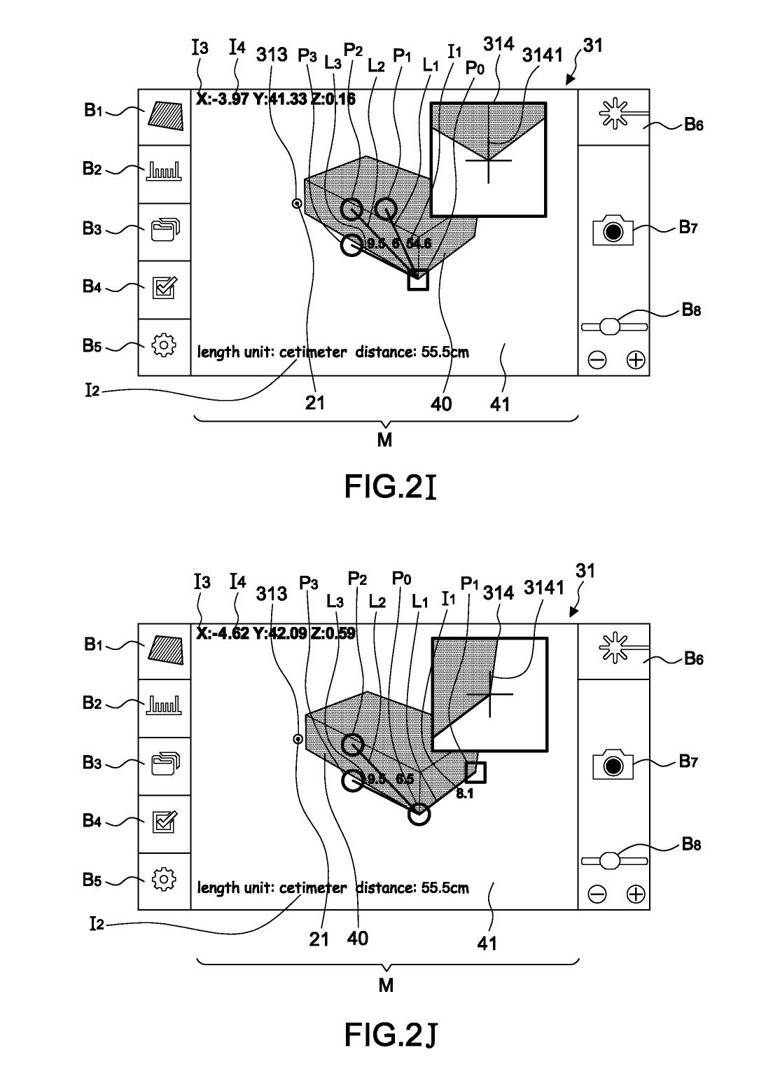

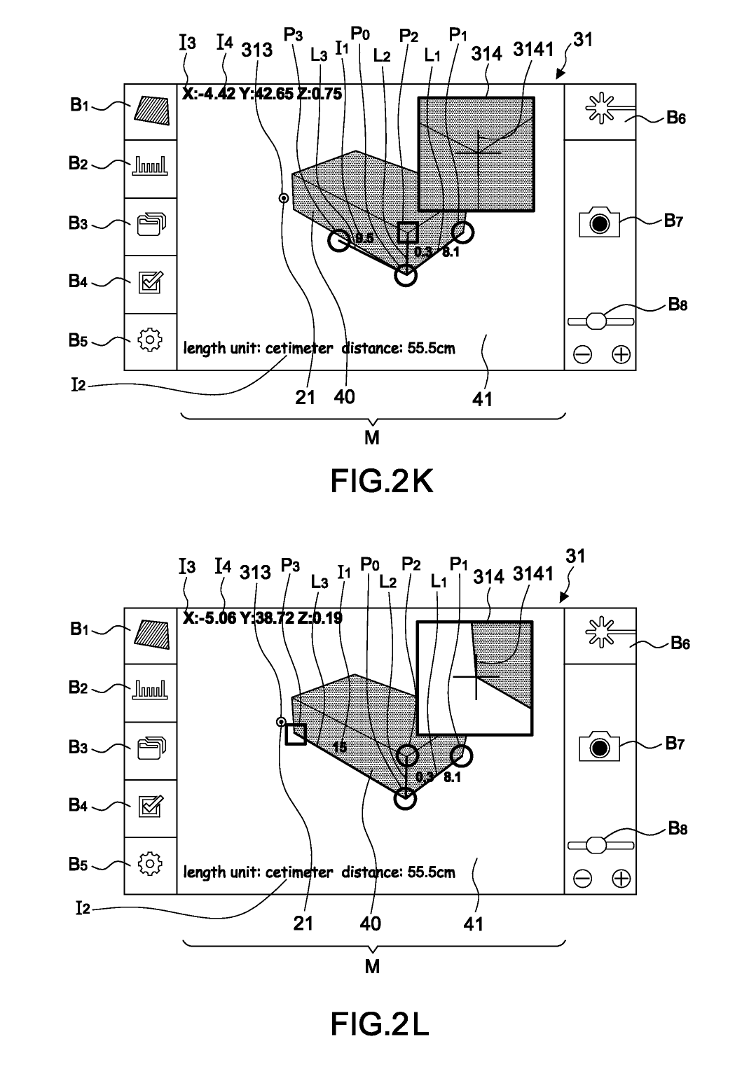

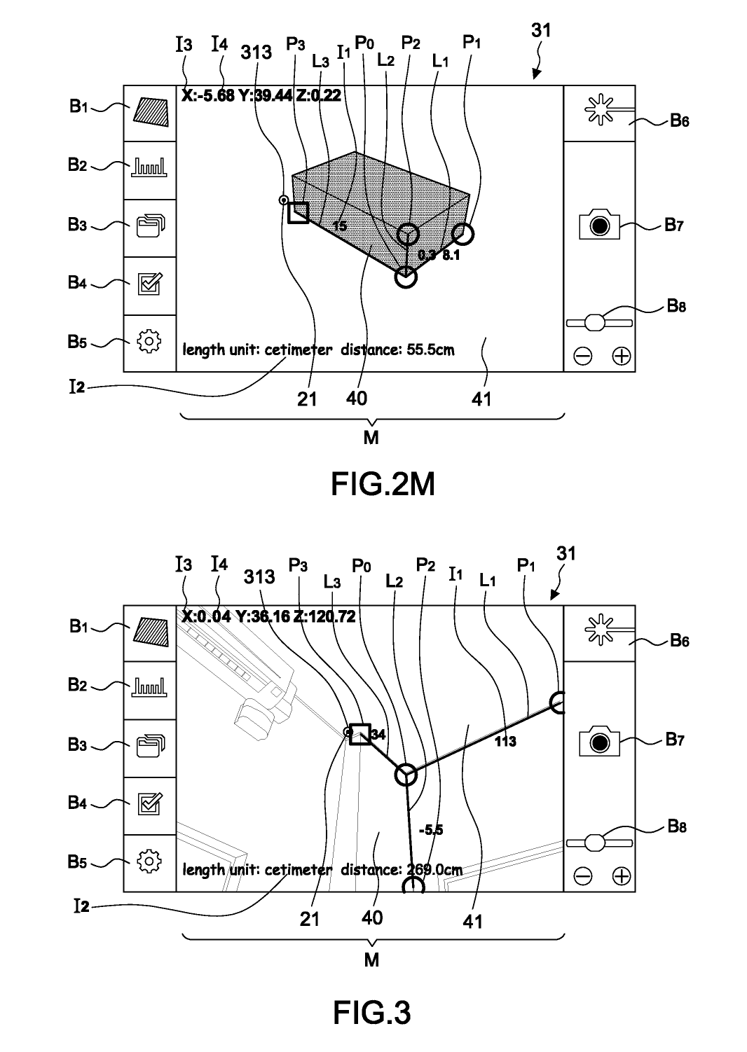

Referring to FIG. 2A, the camera screen 31 further has a measurement button B₁, a length unit switching button B₂, a data managing button B₃, a calibration button B₄, a setting button B₅, a laser button B₆, a shutter button B₇ and an exposure adjusting button B₈; the measurement button B₁ further displays a distance measuring button B₁₁, a line measuring button B₁₂ and an area measuring button B₁₃. FIG. 2B further illustrates the camera screen 31 displaying the laser point 21, the baseline 311 and the region of interest 312 altogether.

As shown in FIG. 2C, the camera screen 31 displays an object 40 on a base plane 41 and the laser point 21 is projected onto the base plane 41 for adjustment of the baseline 311 on the camera screen 31 in accordance with movement of the mobile device 10; then the region of interest 312 is focused on the laser point 21 for taking an image M on the camera screen 31. In this embodiment, the object 40 is a paper box and the base plane 41 is a desk table in background.

FIG. 2D illustrates the shutter button B₇ being touched for taking the image M with the object 40 and the laser point 21.

FIG. 2E illustrates the image M with the object 40 and the laser point 21 is taken and stored in the memory unit 13; FIG. 2F further illustrates the microprocessor 11 operating the camera program 30 to calculate a position of the laser point 21 and display a reference point 313. In this embodiment, the camera screen 31 displays a secondary window 314 with a cross mark 3141 therein after taking the image M. The secondary window 314 further displays an enlarged view of the laser point 21.

FIG. 2G shows illustrates the shutter button B₇ being touched for taking the image M with the object 40 and the laser point 21 in the secondary window 314.

In FIG. 2H, after reference point 313 is focused on the camera screen 31, a first measuring line L₁, a second measuring line L₂ and a third measuring line L₃ are displayed near the reference point 313; the first, second and third measuring lines L₁, L₂, L₃ are connected to a basepoint P₀ with an end thereof and respectively having a first measuring point P₁, a second measuring point P₂ and a third measuring point P₃ at another end thereof. In the embodiment, the secondary window 314 on the camera screen 31 further displays a partially enlarged view of the object 40.

In FIG. 2I, the basepoint P₀ is moved to a point of the object 40 for three-dimensional measurement, and FIGS. 2J-2M showed the object 40 in the taken image M respectively measured by the first, second and third measuring points P₁, P₂, P₃. In the embodiment, position of the basepoint P₀ on the camera screen has to be selected for operation and the first, second and third measuring points P₁, P₂, P₃ are selected for corresponding measuring lines L₁, L₂, L₃ to be adjusted for measurement; each measuring line L₁, L₂, L₃ has a measurement data I₁ displayed nearby on the camera screen. When either of the points is selected, the selected point is surrounded by a square on the camera screen 31 for distinguishment.

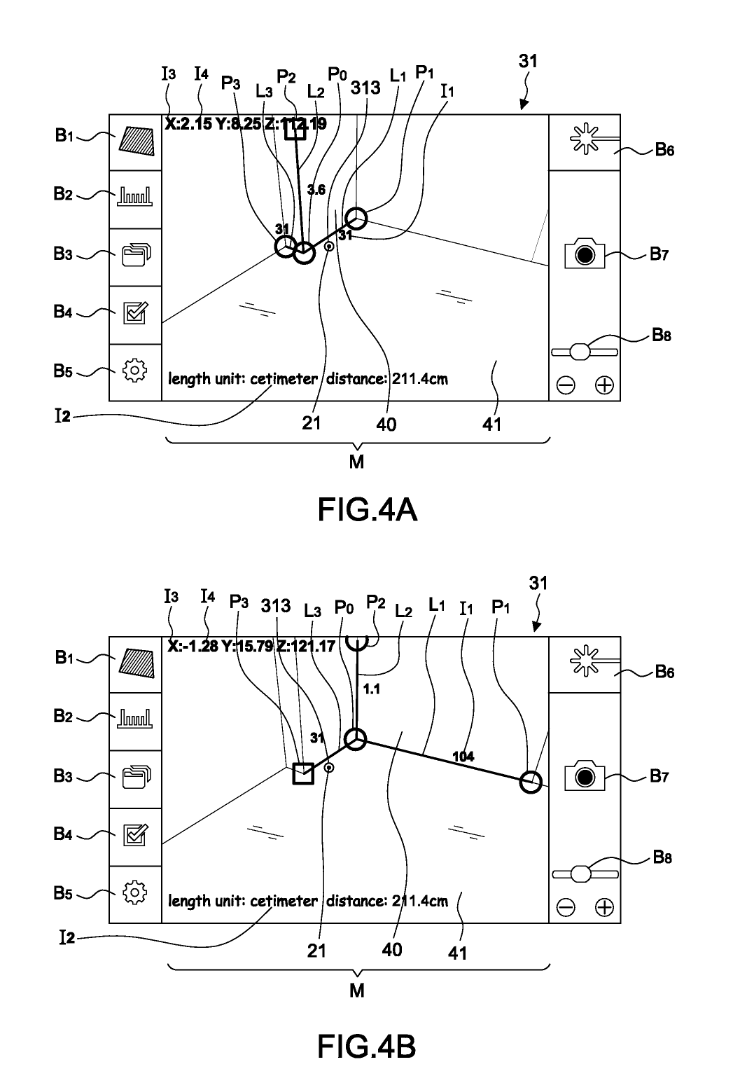

FIGS. 3-4B illustrate another embodiment of the present invention applied in interior building measurement. In FIG. 3, the base plane 41 is a ceiling of a building and the object 40 is a corner of a pillar. In FIGS. 4A and 4B, the base plane 41 is a floor of the building and the object 40 is another corner of the pillar.

In addition, the camera screen 31 also displays other information. For instance, a distance data 12 displaying a distance between the laser module 20 and the laser point 21 is transmitted to the microprocessor 11 for display on the camera screen 31. On the other hand, the mobile device 10 further comprises a gyroscope 15 for collecting a triaxial data I₃ and an accelerometer 16 for collecting a displacement data I₄. Both triaxial data 13 and displacement data I₄ are transmitted to the microprocessor 11 for display on the camera screen 31.

With the structure disclosed above, the mobile device 10 may further comprise a wireless transmitter 17 for transmission of the taken image M to another mobile device with the camera program 30 to share the measurement results or to perform measurements on another mobile device. In other words, the present invention enables instant measurement after taking a photo of an image and stores the image and the results for further usage and applications; it also allows photos taken in other places by other devices to be measured later by the mobile device 10 with the camera program 30 after transmission, thereby enhancing efficiency and provide conveniences for its users.

What is claimed is:

1. A camera program with image measurement for mobile devices, comprising:
a mobile device including a microprocessor electrically connected to a touch screen, a memory unit and a camera lens;
a laser module coupled to said mobile device and operated by said microprocessor of the mobile device to project a laser point; and
a camera program installed in said memory unit and operated by said microprocessor to activate the laser module for projection, operate the camera lens and display a camera screen on said touch screen, said camera screen having a pre-arranged baseline and a region of interest;
whereby the camera screen displays an object on a base plane and the laser point is projected onto the base plane for adjustment of the baseline on the camera screen in accordance with movement of the mobile device; the region of interest is focused on the laser point for taking an image of the camera screen with the object and the laser point therein and storing the image in the memory unit; the microprocessor operates the camera program to calculate a position of the laser point and display a reference point, then a first measuring line, a second measuring line and a third measuring line near said reference point, said first, second and third measuring lines connected to a basepoint with an end thereof and respectively having a first measuring point, a second measuring point and a third measuring point at another end of each measuring line; and the basepoint is moved to a point of the object for three-dimensional measurement by the first, second and third measuring points.

2. The camera program with image measurement for mobile devices as claimed in claim 1, wherein the camera screen displays a secondary window with a cross mark therein after taking the image, said secondary window displaying a partially enlarged view of the image.

3. The camera program with image measurement for mobile devices as claimed in claim 1, wherein position of the basepoint on the camera screen is selected for operation and the first, second and third measuring points are selected for corresponding measuring lines to be adjusted for measurement, each measuring line having a measurement data displayed nearby on the camera screen.

4. The camera program with image measurement for mobile devices as claimed in claim 1, wherein the camera screen further has a measurement button, a length unit switching button, a data managing button, a calibration button, a setting button, a laser button, a shutter button and an exposure adjusting button.

5. The camera program with image measurement for mobile devices as claimed in claim 4, wherein the measurement button further displays a distance measuring button, a line measuring button and an area measuring button.

6. The camera program with image measurement for mobile devices as claimed in claim 1, wherein a distance data between the laser module and the laser point is transmitted to the microprocessor for display on the camera screen.

7. The camera program with image measurement for mobile devices as claimed in claim 1, wherein the mobile device further comprises a gyroscope for collecting a triaxial data and an accelerometer for collecting a displacement data, said triaxial data and displacement data transmitted to the microprocessor for display on the camera screen.

8. The camera program with image measurement for mobile devices as claimed in claim 1, wherein the mobile device further comprises a wireless transmitter for transmission of taken image to another mobile device with the camera program.

9. The camera program with image measurement for mobile devices as claimed in claim 1, wherein the laser module is coupled to the mobile device either internally or externally.
